(19) United States
(12) Patent Application Publication
(10) Pub. No.: US 2008/0248253 A1
(43) Pub. Date: Oct. 9, 2008

(54) Procedural Functional Element of a Stack of Films

(75) Inventors: Thomas Bieber, Kelkheim (DE); Rolf Dahlbeck, Bochum (DE); Marcel Dierselhuis, Soest (NL)

Correspondence Address: SCHNADER HARRISON SEGAL & LEWIS, LLP, 1600 MARKET STREET, SUITE 3600, PHILADELPHIA, PA, 19103, US

(73) Assignee: Syntics GmbH, Bochum (DE)

(21) Appl. No.: 11/908,339

(22) PCT Filed: Mar. 16, 2006
(86) PCT No.: PCT/EP06/02423

§ 371 Date: Feb. 27, 2008

(30) Foreign Application Priority Data
Mar. 17, 2005 (DE) 10 2005 012 415.1

(51) Int. Cl. B32B 3/00

(52) U.S. Cl. 428/161

(57) ABSTRACT

For a procedural functional element formed from a stack of films or plates provided with microstructures, on at least one side of the films a thin film coating is provided, which extends into the microstructures from the coated side so that the thin film coating forms both a surface seal between films lying on one another and a protective layer for the material of the films against aggressive media.

The invention relates to a procedural functional component (so-called “unit operation”) of a stack of films or plates provided with microstructures, in particular a microreactor for chemical, pharmaceutical or biotechnological processes. Here, the term “microreactor” is not limited to a reactor component, but also comprises for example heat exchangers, heaters, mixers, separators or combined miniaturized operation elements, that is, combinations of, for example, heaters, mixers, heat exchangers, reactors, and separators. The function of these operation elements is monitored in this connection by integrated or external sensors (for example throughflow sensors, temperature sensors, pressure sensors, pH sensors, conductibility sensors, tarnishing sensors, particle sensors) and controlled by integrated or external actuators (for example valves).

DE 199 59 249 A1 describes films stacked on one another and pressed firmly together. Fluid sealing between the films is achieved by corresponding fitting; if necessary, a graphite film seal or an inserted sealing element is additionally used. According to DE 197 46 583 A1, the fluid sealing is carried out by pressing together the finely processed surfaces and/or seals, for example O-ring seals or flat seals. These methods have the disadvantage that either precisely under higher pressures the sealing effect is insufficient for gases, in particular for small molecule sizes or low viscosity liquids (for example pentane, dimethylether, dichlormethane), or that complex positioning of the sealing elements is required. Furthermore, the films or plates are not protected from aggressive media. Film or plate materials which can be easily structured for example by chemical etching, are however also prone to corrosion attack by aggressive media which are frequently present in chemical processes. On the other hand, suitably resistant materials (for example Hastelloy or tantalum) must be manufactured in an expensive and complex operation (for example laser structuring, micromilling or electrical discharge machining).

In DE 102 03 212 A1, a surface seal is applied to a wafer by a screen printing method and/or a stencil printing method and/or a dispensing method. This thick-film method is not suitable for microreactors with structure sizes in the range of 10 μm. Furthermore, thin films cannot be applied using this method, and in particular geometrical coating cannot be achieved, that is, the microstructures become “blurry”.

Alternative methods for fluidic sealing consist in joining the films or plates to one another by diffusion soldering or diffusion welding. However, this prevents later separation of the films or plates, for example for cleaning purposes.

Consequently, the invention is based on the object of effecting cost-effective sealing between the films and simultaneously guaranteeing protection of the stacked films or plates from aggressive media.

This object is solved by the features in claim 1. By means of the thin film coating between the individual films, reliable sealing is achieved, and simultaneously, by forming the thin film coating into the microstructures, the protection of the film material from aggressive media is guaranteed.

It is possible to adapt the surface to different requirements, for example to equip it hydrophilically or hydrophobically (for example by suitable plasma treatment) to avoid the accumulation of solid deposits or to improve gliding properties of the media used or as a biocompatible coating. Hereby, it is simultaneously achieved that even simple and cost-effectively structured materials can be used for the films or plates.

Furthermore, it is possible to form the coating to be biocompatible.

The invention solves the object of providing a procedural functional component having films with particularly fine microstructures (for example smaller than 50 μm) with a high aspect ratio without having to apply complex microstructuring (for example the LIGA method).

This object is solved by the features in claims 10 and 11. Due to a conformal coating, simply manufactured structure dimensions larger than 50 μm can be reduced cost-effectively to dimensions of significantly less than 50 μm. In this way, for example, nozzle structures for microemulsifier apparatuses can be produced.

Thin films or plates, preferably provided on at least one side with microstructures by an etching procedure, are appropriate for use. In this context, the word microstructures means structures smaller than 1 mm in at least one dimension. These microstructures can in particular have the shape of channels, bores, through-holes or chambers, and they serve for handling fluids. In this context, the word fluids is to be understood very broadly and is not limited to liquids, but also comprises gases, emulsions, dispersions, mixtures of the most varied kind, multi-phase liquid systems, supercritical media etc.

These structured films or plates are provided on at least one side with a thin, flexible coating extending into the microstructures, for example in a CVD (chemical vapor deposition) process. The thin film coating 2 consists advantageously of an organic compound, in particular of a high molecular organic compound, or of an anorganic compound. The thin film coating consists in particular of poly-para-xylylene, (—CH₂—C₆H₄—CH₂—)ₙ or substituted poly-para-xylylene, in which all of the methylene groups or a part thereof are completely or partly substituted and/or all or a part of the aryl bodies (—C₆H₄—) are completely or partly substituted (for example by —F, —Cl, —NH₂, —CH₂NH₂).

Part of the aryl bodies means, for example, 10%, 50% or 90% of the aryl bodies, wherein the substitution percentage can be set continuously from 0% to 100%. For example: a 10% substitution of the aryl bodies by fluorine (—F) then means ((—CH₂—C₆H₄—CH₂—)ₓ(—CH₂—C₆H₃F—CH₂—)_{y})ₙ with x=9 and y=1.

This coating is particularly appropriate for the fulfillment of the set object because, depending on the substitution or the surface treatment performed, it
has an even layer thickness which maintains its profile,
enables layer thicknesses of 10 μm and less,
is free from pinholes and
biocompatible,
allows very good coating of small gaps,
has very good gliding properties and
good thermal stability,
serves as a gas barrier,
has strong resistance to most aggressive chemicals (for example acids, bases and solvents),
exhibits hydrophobic or hydrophilic properties, and
simultaneously functions as a surface seal due to its mechanical and elastic properties.

For example, a partial substitution of the aryl bodies by amino groups (—NH₂) or substituents containing amino groups results in a biocompatible surface.

In a further embodiment, the thin film coatings consist of polytetrafluoroethylene (PTFE), a polysiloxane or graphite.

Exemplary embodiments of the invention are explained in more detail below with reference to the drawing, in which

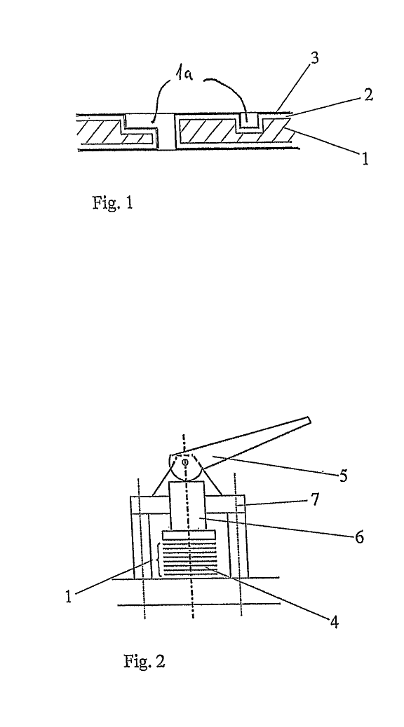

FIG. 1 shows a single film with microstructures in cross section,

FIG. 2 shows a stack of films in a pressing means,

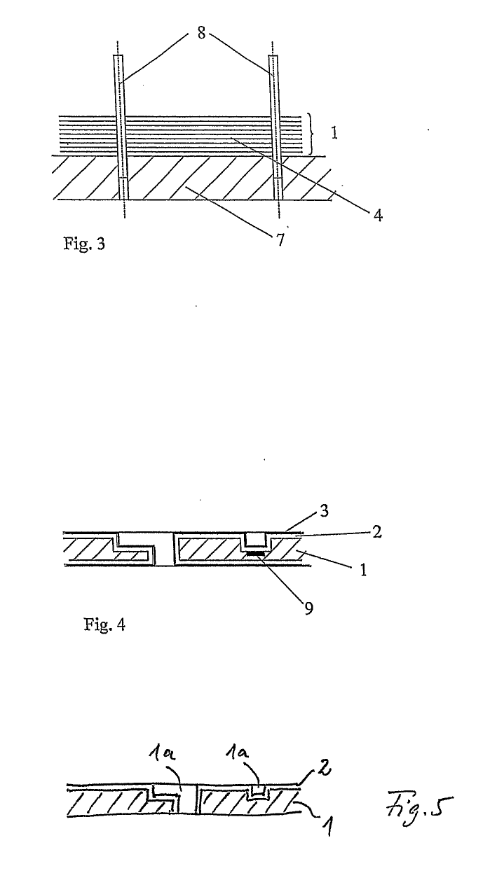

FIG. 3 shows the guiding of the films on positioning pins,

FIG. 4 shows the arrangement of a thin layer temperature sensor, and

FIG. 5 shows a modified embodiment in a view corresponding to FIG. 1.

FIG. 1 schematically shows a thin film coating 2 on a structured film 1. A procedural functional component results by a plurality of similarly and/or differently structured films or plates 1 being stacked over one another. This stack of films or plates 4 is inserted, for example, into a housing of a process guidance module 7, as is known from DE 10 2004 037 059.1.

In the embodiment according to FIG. 1, the thin film coating 2 extends over the whole surface of the film 1 including the microstructures 1a, so that the material of the film 1 is completely enclosed by the thin film coating 2. Hereby, on the surface and underside of the film 1 a sealing effect of the thin film coating 2 is realized between the stacked films, and due to the enclosing of the microstructures by the thin film coating, effective protection of the material of the films 1 from aggressive media flowing through the microstructure is achieved.

A simple, easily structured stainless steel can be used as film or plate material, because the coating 2 effectively prevents attack by corrosive media on the film or plate material. However, it is also possible to use titanium, glass or ceramic material for the plates 1, wherein, however, these materials are more difficult to structure for forming the microstructures. The coating 2 allow the use of an easily-etched material for the films or plates 1 which is not resistant to corrosion.

The stack of films or plates 4 in FIG. 2 is fixed in the housing 7 by means of a pressing means so that a connection which is leak-proof for fluids occurs on the one hand between the individual films or plates 1 and on the other, between the stack of films or plates 4 and the housing 7. As an example of a pressing device, in FIG. 2 an eccentric lever 5 is shown which acts on the stack of films or plates 4 by means of a die 6. However, other pressing devices are also possible, for example frames, clamps or pressing by means of screw connections.

In an advantageous way, the single films or plates 1 are stacked and guided by means of fixation elements. FIG. 3 shows an example of the use of positioning pins 8. These positioning pins 8 are dimensioned such that the single films or plates guided by the pins 8 can be pulled apart from one another in the stacking direction, without losing their position relative to one another. In this form, they can be cleaned in a convenient way, for example in a medium using ultrasound treatment.

Advantageously, the stacks of films or plates 4 can also be used without an additional housing.

For the applications in which the properties of the thin film coating are not sufficient, in an advantageous embodiment the thin film coating 2 can simultaneously serve as a base layer for a further coating 3 (for example polytetrafluorethylene) as shown in FIG. 1, extending preferably over the whole surface of the thin film coating 2, that is, also into the microstructures 1a, wherein the microstructures are completely covered.

As conventional etching methods only allow the smallest microstructure dimensions in the range of the film thickness, the thin film coating 2 is additionally or even exclusively used to geometrically downsize the microstructures 1a. It is very complex and not possible using low-cost methods (for example wet chemical etching) to produce fine microstructures having a channel width smaller than 50 μm with a channel depth of greater than 100 μm. As FIG. 1 schematically shows, the coating 2 is applied such that the coarser microstructures are exactly reproduced by the coating. The result is an angle-preserving coating of the structures.

In a further advantageous embodiment, the thin film coating 2 is used to protect sensor or actuator elements embedded in the microstructure from aggressive media flowing through the microstructures. In this way, these elements enter into significantly closer contact with the medium. Thus the temperature of a medium can be measured significantly more precisely and with a higher dynamic than with a temperature sensor mounted outside the fluid channel. FIG. 4 shows an example of the positioning of a thin film temperature sensor 9 embedded in the film 1, under the thin layer coating 2. In an analogous way, for example heater elements can also be fitted in microreactors.

Further methods of applying the thin film coating 2 apart from the CVD method can be sputter, plasma or vapor deposition methods or plasmapolymerization methods or combinations of these methods. Additionally, the sol-gel process is suitable.

FIG. 5 shows an embodiment in which the thin film coating 2 is applied on only one side of the film 1 such that the thin film coating 2 extends from the coated side into the microstructures 1a and also covers the areas of the microstructures which are vertical or offset to the coating planes. If films of this type are stacked over one another, a layer of the thin film coating 2 forms a seal between the single films 1, and this layer protects the material thereof because due to the stacking, the film material is enclosed on all sides by the protective thin film coating 2.

Because the thin film coating 2 is applied by one of the cited methods, microstructures can also be completely covered which have indentations.

According to the invention, the application of the thin film coating is also used to reduce the dimensions of microstructures in films or plates in a cost-effective way. Here, independent of the coating of one or both sides of a film by one of the cited methods, for example by vapor deposition, a conformal, that is, microstructure-reproducing thin film coating is applied to the microstructures. This type of reduction of the dimensions of microstructures can also be carried out independent of the construction of procedural functional components on films or plates or other components, for example of a microreactor.

The application of the coating 2 for reducing the fluidic channels of the microstructures can also be used in the case of a corrosion-resistant material for the films or plates 1 which do not require any coating with regard to corrosion resistance. Due to coating in order to reduce the microstructures, the advantage results that complex microstructuring methods in particular for materials which are difficult to etch, need not be used. Due to the coating, above all extremely small nozzle structures can be formed, through which for example very fine emulsions can be produced.

1. Procedural functional component formed from a stack (4) of films of plates (1) provided with microstructures (1a),
characterized in that
the films or plates (1) are provided on at least one side with a thin film coating (2) extending from the coated side into the microstructures, so that the thin film coating (2) forms both a surface seal between films lying on one another and a protective layer for the material of the films against aggressive media which flow through the microstructures.

2. Functional component according to claim 1, wherein the thin film coating (2) is formed on both sides of the film (1) and encloses the film material on all sides.

3. Functional component according to claim 1, wherein the thin film coating (2) consists of an organic compound, in particular a high molecular organic compound, or an anorganic compound.

4. Functional component according to claim 1, wherein the thin film coating (2) consists of poly-para-xylylene or substituted poly-para-xylylene in which all or a part of the methylene groups are completely or partly substituted and/or all or a part of the aryl bodies (—C₆H₄—) are completely or partly substituted.

5. Functional component according to claim 1, wherein the thin film coating (2) is formed hydrophobically or hydrophilically to prevent the accumulation of solids.

6. Functional component according to claim 1, wherein the thin film coating (2) is formed to be biocompatible by substitution with amino groups or substituents containing amino groups.

7. Functional component according to claim 1, wherein the thin film coating (2) forms a base layer for a further coating (3).

8. Functional component according to claim 1, wherein the thin film coating (2) or the further coating (3) serves by the functionalization thereof to connect a catalyzer.

9. Functional component according to claim 1, wherein under the thin film coating (2), sensor elements (9) or actuator elements are integrated in the film (1) and are covered by the thin film coating.

10. Method for reduction the dimensions of microstructures (1a) in films or plates (1) which are used in particular for procedural functional components, wherein a thin film coating (2) is applied to the microstructure.

11. Films or plates having microstructures (1a), wherein at least for individual microstructures a conformal thin film coating (2) or such a coating reproducing the same is applied to reduce the dimensions of the microstructure.
